(19) United States
(12) Patent Application Publication
(10) Pub. No.: US 2020/0364132 A1
(43) Pub. Date: Nov. 19, 2020

(54) SYSTEM AND METHOD OF WRITING, PLANNING AND EXECUTING MANUAL TESTS UTILIZING HOSTING SERVICES FOR VERSION CONTROL AND PROJECT BOARDS

(71) Applicant: S2 Technologies, Inc., Encinitas, CA (US)

(72) Inventors: Mark Underseth, Carlsbad, CA (US); Ivailo Petrov, San Diego, CA (US)

(21) Appl. No.: 16/410,806

(22) Filed: May 13, 2019

(51) Int. Cl. G06F 11/36; G06F 8/71; G06Q 10/10; H04L 12/58

(52) U.S. Cl. CPC G06F 11/368; G06F 8/71; G06F 11/3696; H04L 51/16; G06F 11/3664; G06Q 10/101; G06F 11/3688

(57) ABSTRACT

A test manager receives notification by a hosted version control service of one or more files, containing plain text instructions, being stored in a repository to be used for guiding a human tester to perform operations and observe behavior for software under test. The test manager receives notification by a hosted project board service of a board created to be used for tracking the status of a test plan. The test manager retrieves the test plan, defined by metadata provided by the user of the project board hosting service, and communicates with the hosted version control service to select stored files included in the test plan. The test manager communicates with the hosted project board service and creates cards representing the files on the newly created board. The test manager is configured to display a user interface representing the files as manual tests to be executed as part of the test plan. The user interface is also configured to provide guiding instructions, based on the plain text instructions contained in the files stored in the hosted version control service, receive status information from the human tester and send instructions to the project board hosted service to display status information regarding the execution of the tests and status of the test plan.

### BACKGROUND

It should be noted that this Background is not intended to be an aid in determining the scope of the claimed subject matter nor be viewed as limiting the claimed subject matter to implementations that solve any or all of the disadvantages or problems presented above. The discussion of any technology, documents, or references in this Background section should not be interpreted as an admission that the material described is prior art to any of the subject matter claimed herein.

Software teams use a variety of tools during development and a large percentage of teams rely on tools that are provided as hosted services such as project boards and version control.

Exemplary project board hosting services include Jira, Trello, GitHub, GitLab, and Bitbucket. Project board hosting services provide visually depicted work at various stages using cards assigned to unique columns used to represent assigned activity and status.

Exemplary version control hosting services include GitHub, GitLab, and Bitbucket. These examples are based on the open source Git distributed version-control tool. Git is a version control system used for managing source code, documents, and other artifacts providing a complete history and full version-tracking abilities. Software development teams use version control hosting services to store their source code, along with change history and variations of the source code called branches, in repositories.

Software development teams leverage hosted version control services to store and maintain source code, while at the same time use hosted project board services for managing implementation activities related to the source code. Known systems for writing, planning and executing manual tests do not store and maintain manual tests as source code using hosted version control services, while leveraging hosted project board services for managing activities related to manual execution.

Thus quality assurance and development teams are not unified in storing and managing manual tests the same as source code.

### SUMMARY

It is understood that various configurations of the subject technology will become apparent to those skilled in the art from the disclosure, wherein various configurations of the subject technology are shown and described by way of illustration. As will be realized, the subject technology is capable of other and different configurations and its several details are capable of modification in various other respects, all without departing from the scope of the subject technology. Accordingly, the summary, drawings and detailed description are to be regarded as illustrative in nature and not as restrictive.

One aspect comprises a system for writing, planning, and executing manual tests for software under test. The system comprises a processor; and a test manager, executing on the processor. The test manager is configured to be notified in response to the creation of a project board by a project board hosting service, and configured to identify, one or more files containing plain text instructions that are stored and maintained by a version control hosting service. The instructions are to be executed as manual tests by a human tester on the software under test. The test manager is configured to display a user interface having information indicating the manual tests to be executed and to provide guiding instructions for the execution of the tests. The user interface also is configured to receive status information from the human tester. The test manager is configured to send instructions to the project board hosting service to update display information regarding the execution of the tests.

Another aspect comprises a method of testing software. The method comprises receiving a notification in response to the creation of a project board by a project board hosting service. The method identifies one or more files containing plain text instructions that are stored and maintained by a version control hosting service. The instructions to be executed as manual tests by a human tester on the software under test. The method comprises displaying a user interface having information indicating the manual tests to be executed and providing guiding instructions for the execution of the tests. The method receives status information via the user interface from the human tester. The method also sends instructions to the project board hosting service to update display information regarding the execution of the tests.

Yet another aspect comprises a program storage device storing instructions that when executed performs the method comprising receiving a notification in response to the creation of a project board by a project board hosting service. The program storage devices also includes instructions for identifying, one or more files containing plain text instructions that are stored and maintained by a version control hosting service, the instructions to be executed as manual tests by a human tester on the software under test. The program storage device also includes instructions for displaying a user interface having information indicating the manual tests to be executed and providing guiding instructions for the execution of the tests. The program storage device also includes instructions for receiving status information via the user interface from the human tester and sending instructions to the project board hosting service to update display information regarding the execution of the tests.

### BRIEF DESCRIPTION OF THE DRAWINGS

Various embodiments are discussed in detail in conjunction with the Figures described below, with an emphasis on highlighting the advantageous features. These embodiments are for illustrative purposes only and any scale that may be illustrated therein does not limit the scope of the technology disclosed.

FIG. 1 is a block diagram illustrating a system for retrieving and providing information to a version control hosting service and a project board hosting service.

FIG. 2 is a block diagram representing one or more users of the version control hosting service of FIG. 1 committing plain text instructions stored as files into a repository.

FIG. 3 is a flowchart illustrating an end-to-end process of storing files, test planning, manual test execution, and test plan project management using the test manager and the hosting services for version control and project boards of FIG. 1

FIG. 4 is a screenshot of a graphical board that conveys to the user of the project board hosting service of FIG. 1 the status of testing that is performed using the test manager of FIG. 1.

FIG. 5A is an exemplary screen display of the test manager of FIG. 1 that may be used to guide a human tester to perform and track the tests that have been identified by a project board.

FIG. 5B is another exemplary screen display of the test manager of FIG. 1 that may be used to guide a human tester to perform and track the tests that have been identified by the project board.

FIG. 5C is another exemplary screen display of the test manager of FIG. 1 used to display test instructions and receive status and notes from a human tester based on a test identified by the project board.

FIG. 6 is a flowchart illustrating a process by which the test manager of FIG. 1 extracts a copy of the files from the version control hosting service.

FIG. 7 is a flowchart illustrating a process by which the test manager of FIG. 1 transmits the test results and comments from a human tester to a project board.

### DETAILED DESCRIPTION

It is understood that various configurations of the subject technology will become apparent to those skilled in the art from the disclosure, wherein various configurations The following description and examples illustrate some exemplary implementations, embodiments, and arrangements of the disclosed invention in detail. Those of skill in the art will recognize that there are numerous variations and modifications of this invention that are encompassed by its scope. Accordingly, the description of a certain example embodiment should not be deemed to limit the scope of the present invention.

Various aspects of the novel systems, apparatuses, and methods are described more fully hereinafter with reference to the accompanying drawings. The teachings disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the disclosure. For example, a system or an apparatus may be implemented, or a method may be practiced using any one or more of the aspects set forth herein. In addition, the scope of the disclosure is intended to cover such a system, apparatus or method which is practiced using other structure, functionality, or structure and functionality in addition to or other than the various aspects of the disclosure set forth herein. It should be understood that any aspect disclosed herein may be set forth in one or more elements of a claim. Although some benefits and advantages of the preferred aspects are mentioned, the scope of the disclosure is not intended to be limited to particular benefits, uses, or objectives. The detailed description and drawings are merely illustrative of the disclosure rather than limiting, the scope of the disclosure being defined by the appended claims and equivalents thereof.

With respect to the use of plural vs, singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that terms used herein, and especially in the appended claims (e.g., bodies of the appended claims) are intended as “open” terms unless specifically indicated otherwise (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations; or two or more recitations).

In those instances where a convention analogous to “at least one of A, B, and C” is used, such a construction would include systems that have A alone, B alone, C alone; A and B together without C, A and C together without B, B and C together without A, as well as A, B, and C together. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include A without B, B without A, as well as A and B together.” Various modifications to the implementations described in this disclosure can be readily apparent to those skilled in the art, and generic principles defined herein can be applied to other implementations without departing from the spirit or scope of this disclosure. Thus, the disclosure is not intended to be limited to the implementations shown herein but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Certain features that are described in this specification in the context of separate implementations also can be implemented in combination in a single implementation. Conversely, various features that are described in the context of a single implementation also can be implemented in multiple implementations separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

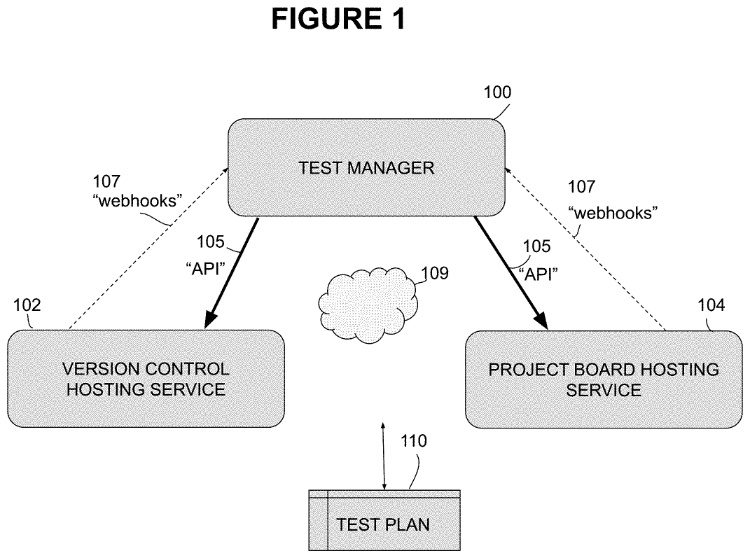

FIG. 1 is a block diagram illustrating a test manager 100 retrieving and providing information concerning hosting services, such as a version control hosting service 102 and a project board hosting service 104.

A test manager 100, in one embodiment, communicates with hosting services' interfaces 105,107 via a network 109. Version control hosting services 102 can be based on the open source Git distributed version control system, which is used primarily for tracking changes in source code during software development. Examples of version control hosting services based on Git that are commercially available products, such as but not limited to are GitHub, Bitbucket, and GitLab. Project board hosting services 104 provide a visual representation of scheduled activities using cards and columns. Project board hosting services can be based on the Kanban board workflow visualization. Examples of project board hosting services that are commercially available products, such as but not limited to are Jira, Trello, GitHub, Bitbucket, and GitLab. The network 109 can include the Internet, a local area network, or a wide area network, or a virtual network being emulated on a point-to-point system. As used herein, a test manager 100 is software that guides a human tester to run at least one test for software under test and to receive status from the human tester.

The test manager 100 may be configured to run on a processor of a computing device, such as a desktop application, or as a server application on the Internet that is accessed by a tester via a web browser. The processor may be any conventional general-purpose single- or multi-chip microprocessor such as but not limited to a x86. x86-64, ARM164, a 8051 processor, a MIPS® processor, a Power PC® processor, or an Alpha® processor. In addition, the microprocessor may be any conventional special purpose microprocessor such as a digital signal processor or a graphics processor. The microprocessor typically has conventional address lines, conventional data lines, and one or more conventional control lines. A human tester accesses one of more user interfaces of the test manager 100 via the network 109 and a network browser of an electronic device connected to the network 109.

The version control hosting service 102 and the project board hosting service 104 export application programming interfaces (“API”) 105 allowing 3rd parties to communicate and provide additional functionality to users of the hosting service. An exemplary API is described in the GitHub Developer Guide, https://developer.github.com/v3/, dated Mar. 26, 2019, which is hereby incorporated by reference in its entirety. As used herein, the API, e.g., GET, PUT, PATCH, POST, and DELETE commands may be used to extract and post information to and from the respective service. The test manager 100, acting as a client, makes a request via the API, to access a user's set of repositories and/or an organization's set of repositories in the version control hosting service 102. A repository is defined as a container of content such as source code. History tracking and revision control are built-into the version control hosting service 102. The test manager 100, acting as a client, may also update the content of the board managed by the project board hosting service 104, For example, under GitHub, see https://developer.github.com/v3/projects/cards.

Thus, there are generally two groups of individuals accessing the version control hosting service: human testers who access certain information from the version control hosting service 102 via the test manager 100 and software developers and/or managers who interface directly with a software development interface of a web portal of the version control hosting service 102. A software developer and/or manager of the version control hosting service 102 may access the service via the network 109 and using a network browser of an electronic device of the developer. Unless proscribed by an organization, a direct user of the version control hosting service is not precluded from accessing the version control hosting service information via the test manager 100 and vice versa. As used herein, a “user of the version control hosting service” refers to an individual who accesses the version control hosting service information 102 directly via a web portal of the version control hosting service 102.

The content of the project board hosting service 104 is generally accessed by software developers and/or managers who interface directly with a software development interface of a web portal of the project board hosting service 104. A software developer and/or manager may access the project board hosting service 104 via the network 109 and using a network browser of an electronic device of the developer. Unless proscribed by an organization, a direct user of the project board hosting service is not precluded from accessing the test manager 100 or the project board hosting service 104. As used herein, a “user of the project board hosting service” refers to an individual who accesses the project board hosting service information 104 directly via a web portal of the project board hosting service 104.

The hosting services 102, 104 and the test manager 100 can be provided by a single commercial product or by multiple commercial products. For example, in one embodiment, the version control hosting service 102 and the project board hosting service 104 are integrated into a single application and the test manager 100 configured as a separate application communicates with the services of each of them via an API provided by the single integrated application. In another embodiment, each of the version control hosting service 102, the project board hosting service 104, and the test manager 100 are integrated into a single application and the respective services are invoked by the services of the other via an internal API or otherwise directly invoked via a private link, API, port, or communication channel. In yet another embodiment, the version control hosting service 102 and test manager 100 are integrated into a single application package and communicate with the project board hosting service 104 via an interface such as described above.

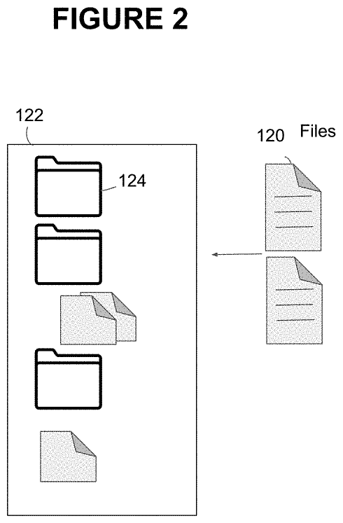

FIG. 2 is a block diagram representing one or more users of a version control hosting service 102 committing files 120 into a repository 122. Files 120 are written instructions using a readable language in plain text, providing a set of instructions for testing software manually. Files 120 containing textual instructions are handled exactly the same as files containing textual based programming language instructions (e.g. source code) when being stored and maintained in a repository 122. The files 120 can be organized and version controlled within folders/sub-folders 124 and separate branches of the repository 122. A branch is a controlled variation of an existing baseline within a repository. As will be described further below, the test manager 100 may be used to extract the files 120 from the repository 122 and convey information about the files 120 represented as tests 120 back to the project board hosting service 104. In one embodiment, the files 120 are plain text files using a lightweight markup language such as, but not limited to, markdown or textile, defining one or more manually triggered or operations to be performed on the software under test by a human tester. The files 120 themselves can reference, but not limited to, external links and images. Images can be stored in the repository 122 or elsewhere. In another embodiment, the files 120 are plain text files using a business driven development language format, but not limited to, such as Gherkin. The software under test could be maintained with the same repository 122, or elsewhere.

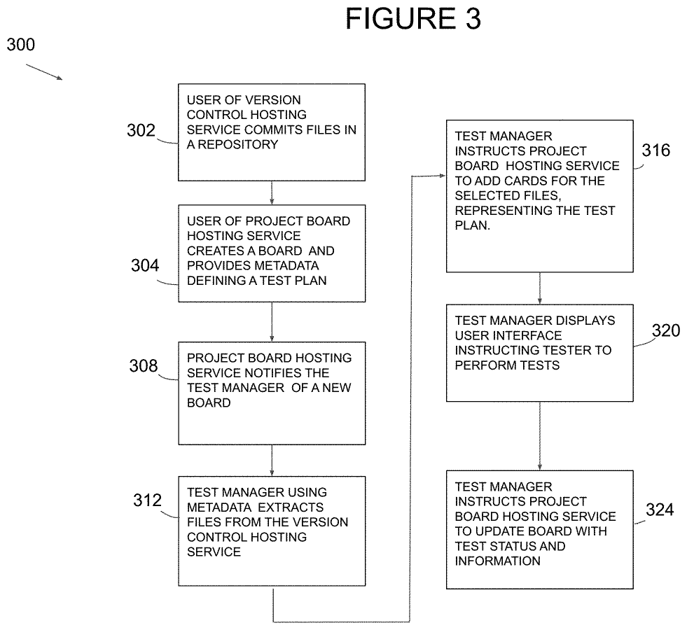

FIG. 3 is a flowchart illustrating an end-to-end process of file storage, test planning, manual test execution, and test plan project management using the test manager 100, the version control hosting service 102, and the project board hosting service 104. Depending on the embodiment, the hosting services can be provided by a single commercial product or by separate commercial products. Also, additional steps may be added, others removed, and the ordering of the steps rearranged.

Starting at step 302, a user of the version control hosting service commits files 120 in a repository 122. At step 304, a user of the project board hosting service 104 creates a visual “project board.” The user defines the name of the project board and provides metadata, used to identified one or more files 120 as a test plan 110 (FIG. 1) that is used to manage the test execution project with respect to the software under test. The project board is a visual representation of the test plan 110. In addition to defining which files 120, the metadata can define the following: the location of the files, e.g., a file path, files to ignore, and which branch of the code to utilize.

Set forth below is certain exemplary metadata that may be used to configure the file inclusion test plan criteria.

| | |
|---|---|
| repo: “url” | # location of repo |
| branch: “branch name” | # default is “master” |
| specs: | |
| - path: “/path/to/specsX” | # default is “/specs” |
| ignore: | |
| - “**/x*” | |
| - path: “/path/to/specsY” | |
| ignore: | |
| - “**/y*” | |

The keyword “repo” indicates the following text defines the location of the repository 122 of the version control hosting service 102, The keyword “branch” indicates the following text defines a branch of the repository 122. In the example above “/path/to/specsX” is a relative file path location within the repository 122, The keyword “path” indicates the following text defines a location of the files 120. The keyword “ignore” indicates the following text defines criteria of the name of files to be excluded from being tested where “glob” patterns could be used.

Metadata used to defined the test plan can be persisted within, but not limited to, the project board hosting service 104, the version control hosting service 102, or the test manager 100.

Continuing to a step 308, the project board hosting service 104 notifies the test manager 100 of the existence of the new project board. In one embodiment, the test manager 100 previously registered, via an application programming interface (“API”), with the project board hosting service 104 to receive a notification via a webhook 107 when a new project board is created.

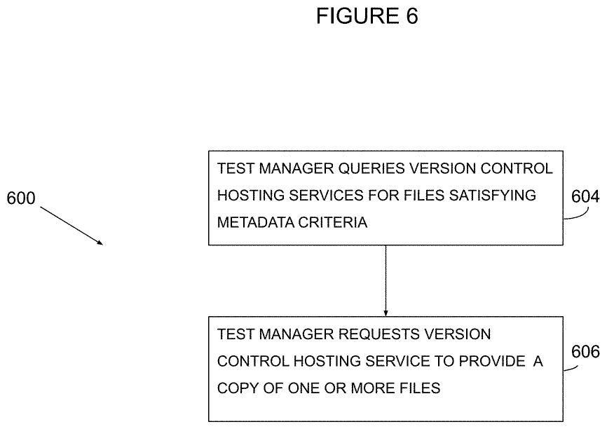

Next, at step 312, the test manager 100, in one embodiment, utilizing the API of the version control hosting service 102, extracts a copy of the files 120 in the repository 122. The location and the name of the files 120 are identified by the metadata. In one embodiment, the files 120 are then stored locally on a computer hosting the test manager 100. An exemplary process of extracting files used to define the test plan 110 via the metadata is described below with respect to FIG. 6.

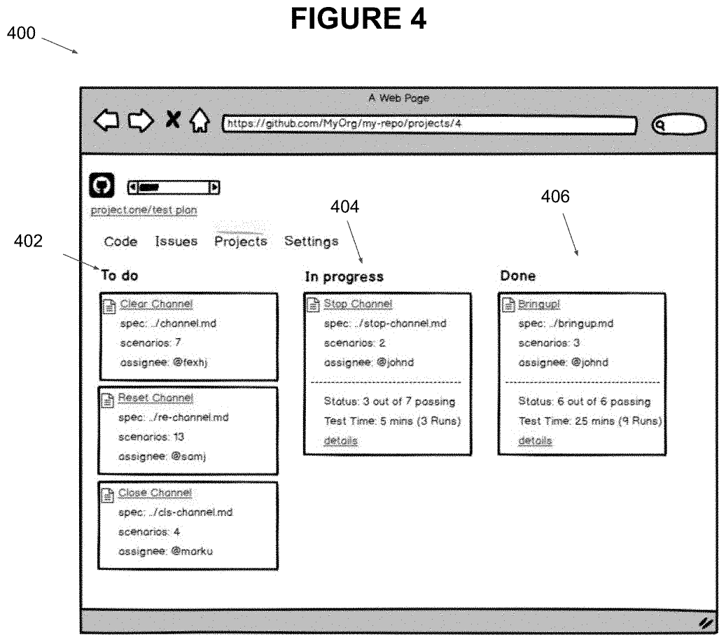

Proceeding to step 316, the test manager 100 instructs the project board hosting service 104 to add graphical cards to the existing visual board 400 (FIG. 4), to be used for test plan management. In one embodiment, the board 400 has graphical cards representing the files now known as the test plan. In one embodiment, the type of board is kanban. The card information may include but is not limited to the following: the name of the file, name of the tests associated with the file, whether portions of the tests have started, which of the tests have been executed, information indicating the pass or failure of the tests, a state of the tests and/or a name of any tester that performed the tests. An exemplary graphical board is shown in FIG. 4 (described below).

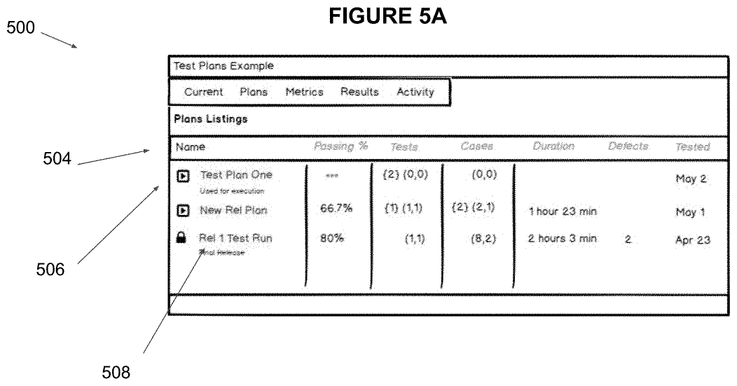

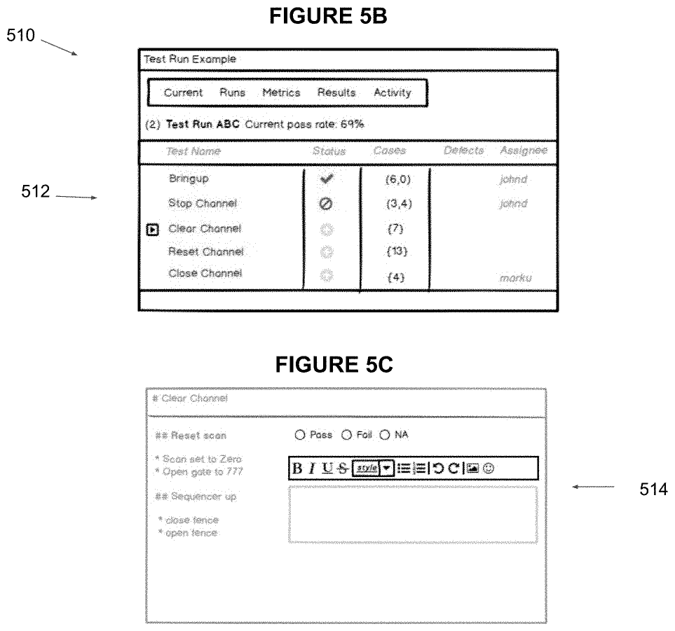

Moving to a step 320, the test manager 100 displays a user interface 500 (FIG. 5A) that includes information guiding a tester to perform operations and observe behavior based on the extracted files from the version control hosting service 102 as visually reflected by a project board representing the test plan 110 from the project board hosting service 104. The user interface can include: a window displaying the name of the tests, a graphical control to trigger the execution of the test, a form allowing the tester to specify whether the test passed or failed, and any notes the tester may have regarding the execution of the test. The user interface 500 can also be adapted to show a name of a tester that had been assigned by a user of the project board hosting service 104 to perform the test. Exemplary screen displays 500 and 510 for the user interface are described below with reference to FIGS. 5A and 5B.

Next, at step 324, the test manager 100 instructs, in one embodiment, via the application programming interface, the project board hosting service 104 to update a card attached to the visual board 400 with the results from the human tester. In one embodiment, the card containing the updated information from the human testers may be moved to a different column representing the state of the test.

FIG. 4 is a diagram of a board 400 that conveys to the user of the project board hosting service 104 the status of the test plan 110, The board 400 includes three columns 402, 404, and 406 each including a number of cards. Each of the cards contain information about the name of the test, source of the test, i.e., the location of the file, a name of a tester that has been assigned to the test, if the test has started yet, and a status of whether the test is passing or failing. A status of the test may be reflected in the card by textual information or by a graphical icon representing pass and failure. Column 402 includes the cards of tests that are “To do”, reflecting the assignment of tests by the user of the project board hosting service 104. Column 404 includes the cards of tests that are “In progress”, reflecting manual testing has started, Column 406 includes the cards of tests that are “Done.” The card can also include any notes that have been generated by a tester regarding the test. It is noted that project board hosting services can use different logical constructs to represent a card such as: “issues” which can also be used for tracking bugs and requirements; lightweight user interface forms (e.g. GitHub Notes); and other user interface widgets. It is also noted that additional columns and or cards can be added (or deleted) by the user of the project board hosting service 104, independent of the test manager 100.

FIG. 5A is an exemplary screen display 500 of the test manager 100 user interface that may be used to guide a human tester to perform and observe tests 120 that have been identified by the test plan 110, as represented in a board maintained by the project board hosting service 104. The display includes a plurality of rows of information, each corresponding to an instance of a project board created by a user of the project board hosting service 104. There is no limit to the number of unique project boards. A “plan” is a logical construct used by the test manager 100 for representing the test plan as visual displayed on the project board. As shown in FIG. 5A, the name of a respective project board is in the name column 504. An example is “Test Plan One” 506. The test manager 100 may display the number of tests in the respective test plan that have passed, the number that have failed, and the number of tests that have not yet started. Additional information may be displayed in other columns of the screen display 500 including total test times, current overall aggregates status, and time information indicating when the test execution was started and/or when a portion of the test was last performed.

In one embodiment, when a new project board is created by the project board hosting service 104, the test manager 100 automatically updates its lists of available project boards that are able to be tested by a tester using the test manager 100. Furthermore, when a project board is created, display 500 is automatically updated by the test manager 100 to create a new row describing the project board, such as are shown in rows 508.

The test manager 100, in one embodiment, is configured to be notified via webhooks on changes to one or more files maintained and stored by the version control hosting service 102. The test manager 100 extracts a new copy of the files identified by the test plan and stores an updated copy of the identified files and removes cards no longer applicable based on the changes applied in the version control hosting service 102.

The test manager 100, in one embodiment, is also configured to be notified on changes to test plan's metadata used in identifying the name and locations of one or more files maintained and stored by the version control hosting service. The test manger 100 is configured to provide instructions to the project board hosting services 104 to update and remove cards no longer applicable based on the updated metadata.

In one embodiment, the displayed name of the project board is selectable via a link and upon selection displays further information regarding the set of tests contained in a specific project. For example, the project name “Rel 1 Test Run” 508 shows an example of a link that may be used to redirect to a new view that is used to convey such further information.

FIG. 5B is another exemplary screen display 510 of the test manger 100 that may be used to guide a tester to perform and track the tests that have been identified by a project board representing files maintained in the repository 122. The display may include columns of information, each row in the columns corresponding to a test defined by the project board. In this instance, a list of tests 512 collectively define a test plan.

FIG. 5C is another exemplary screen display 510 of the test manager 100 that may be used to guide a tester to execute a specific test. In one embodiment, the displayed name of each of the tests and is selectable via a link and upon selection displays further information regarding each test case of the respective test. Using the test manager 100, the tester can trigger the execution of each of the test cases, indicate whether the test case passed or failed, and also optionally provide any information 514 regarding the execution of the test case. Immediately after or in direct response to the creation of any new tests, or receipt of any comment from the tester, the testing manger 100 updates the content of the board 400 (FIG. 4) of the corresponding project to convey such status updates to a user of the project board hosting system 104.

FIG. 6 is a flowchart illustrating a process 600 by which the test manager 100 uses metadata and the version control hosting service 102 and extracts a copy of the files 120 from the repository 122. Starting at a step 604, the test manager 100 queries the version control hosting service 102 for all files 120 that satisfy the criteria identified in the metadata. Next, in step 606, the test manager 100 requests a copy of each of the files 120 identified in step 604. It is noted that in one embodiment, the process of FIG. 6 is triggered by the receipt of a notification via a webhook from the project board hosting service 104 that a new project was created by a user of the project board hosting service 104. In another embodiment, the process may be triggered when the metadata has been modified, requiring a refreshing of the files currently copied from the version control hosting service 102.

In another embodiment, the process of FIG. 6 is triggered by the receipt of a notification via a webhook from the version board hosting service 102 that one or more files have been changed, added, or removed based on a new commit to the repository maintaining the files.

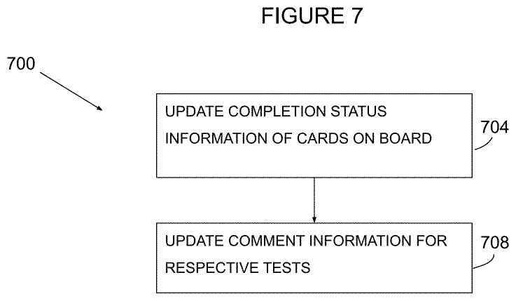

FIG. 7 is a flowchart illustrating a process 700 by which the test manager 100 transmits the test results and comments from a human tester to the project board hosting service 104 and builds graphical cards contained in the project board for a user of the project board hosting service 104 to manage and track the progress of tests.

Starting at step 704, the test manager 100 updates completion status information of cards on the board 400. For example, in response to a tester starting a “test” using the test manager 100, the test manager 100, in one embodiment, updates the board 400 via the API of the project board hosting service 104 to reflect that one or more of the corresponding tests 120 are now being tested. For example, as shown by screen display in FIG. 4, one of the cards “Stop Channel” had been moved from the “To do” column 402 to the “In-progress” column 404. If a tester identifies a test as being completed, the test manager 100, in one embodiment, moves the corresponding card from column 404 to column 406. Continuing to a step 708, the test manager 100 updates the cards on the board 400 via the application programming interface of the project board hosting service 104 with any comments that had been provided by a tester of the application 100.

Instructions or code utilized by or for the testing application 100 may be written in any programming language such as but not limited to C, C++, BASIC, Pascal, or Java. The functions of the testing application 100 may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

What is claimed is:

1. A system for writing, planning, and executing manual tests for software under test, comprising:
a processor; and
a test manager, executing on the processor, the test manager configured to be notified in response to the creation of a project board by a project board hosting service, and configured to identify, one or more files containing plain text instructions that are stored and maintained by a version control hosting service, the instructions to be executed as manual tests by a human tester on the software under test,
the test manager configured to display a user interface having information indicating the manual tests to be executed and providing guiding instructions for the execution of the tests, the user interface also configured to receive status information from the human tester, the test manager configured to send instructions to the project board hosting service to update display information regarding the execution of the tests.

2. The system of claim 1, wherein the test manager retrieves a test plan specified by metadata, identifying the name and locations of one or more files stored and maintained by the version control hosting service, the files containing instructions to be executed by a human tester as manual tests on the software under test.

3. The system of claim 2, wherein the test manager is further configured to extract a copy of the files identified by the test plan and store a copy of the identified files.

4. The system of claim 2, wherein the test plan defines the names of one or more files and the test manager sends instructions to the project board hosting service to create a set of graphical cards for the tests identified by files, the card including the name of the test, and a default status of the test, to be included with the board initially created by the user of the project board hosting service.

5. The system of claim 1, wherein the test manager is configured to receive information identifying a human tester, associated with a specific card in the project board, that has been assigned by a user of the project board hosting service to perform the test.

6. The system of claim 1, wherein the instructions to the project board hosting service include instructions to display on a card in the project board the name of the test, the status of the test, and notes provided by the human tester when testing.

7. The system of claim 1, wherein the test manager is configured to be notified on changes to one or more files maintained and stored by the version control hosting service, the test manager further configured to extract a new copy of files identified by the test plan and store an updated copy of the identified files, the test manager further configured to provide instructions to the project board hosting service to update cards based on the changes.

8. The system of claim 1, wherein the test manager is configured to be notified on changes to the metadata of a test plan, the test manager further configured to provide instructions to the project board hosting service to update cards based on the changes.

9. The system of claim 1, wherein the test manager communicates with each of the project board hosting service and the version control hosting service via an external application programming interface that is exported by each of the respective services.

10. The system of claim 1, wherein the test manager, the project board hosting service, and the version control hosting service are integrated together within a single application.

11. A method of testing software, comprising:
receiving a notification in response to the creation of a project board by a project board hosting service;
identifying, one or more files containing plain text instructions that are stored and maintained by a version control hosting service, the instructions to be executed as manual tests by a human tester on the software under test;
displaying a user interface having information indicating the manual tests to be executed and providing guiding instructions for the execution of the tests;
receiving status information via the user interface from the human tester; and
sending instructions to the project board hosting service to update display information regarding the execution of the tests.

12. The method of claim 11, additionally comprising: displaying a graphical user interface configured to receive information regarding a comment about the execution of the test; and in response to the receiving the comment, sending an instruction to the project board hosting service to display the comment on a board.

13. The method of claim 11, wherein displaying a graphical user interface instructing a tester to perform the one or more tests comprises:
displaying a list of tests;
displaying an interface enabling the human test to execute one or more tests from the list; and
displaying an interface enabling the human tester to provide the status of the execution.

14. A program storage device storing instructions that when executed performs the method comprising:
receiving a notification in response to the creation of a project board by a project board hosting service;
identifying, one or more files containing plain text instructions that are stored and maintained by a version control hosting service, the instructions to be executed as manual tests by a human tester on the software under test;
displaying a user interface having information indicating the manual tests to be executed and providing guiding instructions for the execution of the tests;
receiving status information via the user interface from the human tester; and
sending instructions to the project board hosting service to update display information regarding the execution of the tests.

15. The program storage device of claim 14, additionally comprising instructions that when executed perform the steps of:
displaying a graphical user interface configured to receive information regarding a comment about the execution of the test; and in response to the receiving the comment, sending an instruction to the project board hosting service to display the comment on a board.

16. The program storage device of claim 14, wherein the instructions for displaying a graphical user interface for instructing a tester to perform the one or more tests comprises additional instructions that when executed perform the steps of:
displaying a list of tests;
displaying an interface enabling the human test to execute one or more tests from the list; and
displaying an interface enabling the human tester to provide the status of the execution.
